(19) United States
(12) Patent Application Publication
(10) Pub. No.: US 2023/0328019 A1
(43) Pub. Date: Oct. 12, 2023

(54) Personal Media Communications Over a Non-Commutative Node-Centric Star-Cluster Network

(71) Applicant: Peepline LLC, Incline Village, NV (US)

(72) Inventors: Leopold B. Willner, Petaluma, CA (US); Blake Anderson, North Saint Paul, MN (US)

(73) Assignee: Peepline LLC, Incline Village, NV (US)

(21) Appl. No.: 17/715,906

(22) Filed: Apr. 7, 2022

(51) Int. Cl. H04L 51/212; H04L 9/40

(52) U.S. Cl. CPC H04L 51/212; H04L 63/061

(57) ABSTRACT

Methods and apparatus consistent with the present disclosure may be used to create Internet applications and associated websites that bring human-levels of personal trust and intimacy/closeness into use while people are messaging and posting on a fully secured private peer-to-peer Internet communication system empowered by distributed ledger technology and applications. This invention and its embodiments represent a useful way of bringing personal freedom and personal rights into full use in an objective a subjective manner on the Internet. Meaning an advanced technology that makes manifest the much-needed Enlightenment of the Internet desired by so many thoughtful and concerned people in the United States and within the very vocal leadership of the European Union. Communications sent between devices may be encrypted such that only users of end devices or nodes may receive message data sent from another device.

### BACKGROUND OF THE INVENTION

### Field of Invention

The present invention generally relates to a non-commutative peer-to-peer node-centric rules-based communications between nodes (e.g. computing devices) of a communication network. More specifically, the present invention relates to locally set and controlled rules-based data sharing between nodes using non-commutative signaling between nodes via an electronic communication network.

### Description of the Related Art

One of the great threats to privacy and to the security of computer data relates to how most public computer networks are presently organized and centrally managed. Therein, individuals commonly communicate with each other via an electronic medium where messaging and other data is stored at servers or data storage devices of various companies. Companies that provide services of electronic mail (email), social media communications, and text messaging, that store communication data at a data center operated or leased by these companies. Even when encryption and other security measures are used to protect this data, hackers, spies, corporate intruders and various forms of malware (e.g. spyware & computer viruses) have stolen or otherwise misused data belonging to millions of unknowing private people, along with data mining and personal profiling for commercial purposes. What is needed are new methods and apparatus that secure personal and private data from unwanted access and exploitation by outsiders. What is also needed are communication tools that make both the objective and subjective aspects of communications between individuals effective over networks in ways that emphasize and protect privacy, security, personal trust and intimacy. These are contained in the means and methods of the present invention and its embodiments.

### SUMMARY OF THE CLAIMED INVENTION

The presently claimed invention relates to a method, a non-transitory computer readable storage medium, an apparatus, or as a system of devices. In one embodiment, the presently claimed method may include receiving at a first user device input that identifies a trust level and an intimacy level to associate with a second user. This trust level and the intimacy level may correspond to a sentiment rating of the second user. This method may also include receiving message data at the first user device, identifying that the message data corresponds to the sentiment rating of the second user, and sending the message data to the second user device based on the identification that the message data corresponds to the sentiment rating of the second user and based on the contact information identifying that the second user operates the second user device.

In a second embodiment, a system consistent with the present disclosure may include a first user device that includes a first processor and a first memory that stores instructions of a set of program code. This trust level and the intimacy level may correspond to a sentiment rating of the second user. This first processor may execute instructions out of the memory to receive message data, identify that the message data corresponds to the sentiment rating of the second user, and prepare to send the message data to the second user based on the identification that the message data corresponds to the sentiment rating of the second user. The message data may then be sent to the second user device based on the contact information identifying that the second user operates the second user device.

In a third embodiment, the presently claimed method may be implemented by a non-transitory computer-readable storage medium where a processor executes instructions out of a memory to receive input that identifies a trust level and an intimacy level to associate with a second user. This trust level and the intimacy level may correspond to a sentiment rating of the second user. This method may also include receiving message data at the first user device, identifying that the message data corresponds to the sentiment rating of the second user, and sending the message data to the second user device based on the identification that the message data corresponds to the sentiment rating of the second user and based on the contact information identifying that the second user operates the second user device.

### BRIEF DESCRIPTION OF THE DRAWINGS

FIG. 1 illustrates a series of steps that may be performed at a user device when a user wishes to send messages to other user devices based on trust levels and intimacy levels. firewall.

FIG. 2 includes a series of steps that may belong to step 160 of FIG. 1.

FIG. 3 illustrates actions that may be performed at two different computing devices that part of a node-centric non-commutative communication network.

FIG. 4 illustrates a computing system that may be used to implement an embodiment of the present invention.

FIG. 5 illustrates a first and a second computing device as well as a transfer computing device that may be used to share data in a secure way according to rules and keys discussed in respect to FIGS. 1-3.

### DETAILED DESCRIPTION

Methods of the present disclosure relate to a quasi-peer-to-peer node-centric rules-based communications between the nodes (e.g. specific computing devices) of a communication network. Methods and apparatus of the present disclosure may allow users to set rules that control data sharing between nodes using non-commutative signaling between nodes that communicate via an electronic communications network. Messages or other data may be sent between smartphones, personal computers (e.g. laptops and handheld devices), and private servers via the Internet and/or private networks in a manner that emphasizes security, privacy, personal trust and intimacy in new ways that protect individual rights, common in free societies and mostly absent on an Internet dominated by corporate interests. Methods consistent with the present disclosure enable innovations that empower an Enlightenment of the Internet using the tools of newly minted, so-called “Personal Media.”

Embodiments of the present disclosure may be directed to a method, a non-transitory computer readable storage medium, and other apparatus of a quasi-peer-to-peer fully secured private communications away from the grasp and commercial exploitation of corporate interests and advertisers via big data mining, machine learning and personal profiling, without the specific permission and compensation of the parties concerned. Private information may only be held (i.e. stored or displayed) on private computing devices (e.g. smartphones, laptops, computers, and/or private servers). Private dossiers may be used to store information on personal contacts, this information may be used as a mental prosthesis to enable better, more accurate, trusted and intimate communications among private parties. Methods of the present disclosure may define and enable a new form of Internet and its media architecture that deserves to be characterized as ‘personal media.’ This personal media is empowered by a distributed node topology network that functions via: 1) peer-to-peer (or what may be referred to as a quasi-peer-to-peer) encrypted communications architecture, 2) minimal server interactions, which may always be out of reach of commercial networks and big data intrusions on privacy, 3) ways of communicating among users secured by the highest level of privacy and security enabled by client ratings on trust and intimacy/closeness between individuals, 4) by matching messages to their audience via search, filtering and other capabilities using personal dossiers only stored on users private devices, and thus out of the reach of public and commercial networks, 5) new convenient high speed ways of selecting just the right ad hoc audience for a message or posting, 6) an architecture that fosters and enables the evolution and use of smart contracts, and 7) communication rules and protocols defined on individual peer-to-peer or quasi-peer-to-peer links by the peers themselves that are non-commutative. All of which will tend over time to raise trust and confidence and bring users and user groups ever closer together. In the present disclosure, the terms confidence and sentiment may be used interchangeably, and measures of levels of confidence or sentiment may be a function of measures or levels of trust and intimacy assigned by a particular user.

The terms quasi-peer-to-peer, non-commutative peer-to-peer, quasi-peer-to-peer links, and quasi-peer-to-peer communications may refer to the fact that communication rules between specific compute nodes may be non-commutative. This is because a first rule set at a first user device communicating with a second user device may not be the same as a second rule set at the second user device communicating with the first user device.

In certain instances, methods of the present disclosure include individually centered and controlled personal media wherein all data is kept strictly secure and private and potentially managed within a distributive ledger technology system (DLT) and communicated among users (nodes) of its non-commutative, node-centric data communication network. Personal contacts of each user can be mapped as a group of interconnected nodes representing his or her personal friends, colleagues, and/or family in the form of a star shaped graph with the named user at its center. Each user of his or her non-commutative node-centric star shaped network may assign to each of their contacts a respective rating of trust and a respective rating of intimacy along with other attributes such as interests, preferences etc. Communications sent from a sender user media device may be transmitted according to a set of local rules associated with trust levels (or trust ratings) and intimacy levels (intimacy ratings) defined by a user to each edge of their graph. Individual user devices may be configured to be a node in their own node-centric star network. Communications sent from one node to another node in this network may be transmitted in encrypted form and secured at respective nodes, and data sent from one node to another node may never be stored or housed at any centralized computer system or data center, but, instead only be housed on the user's personal private device such as a smartphone, laptop computer, or personal storage device. By not relying upon a centralized data center to store data sent from one node to another, hackers and those that distribute malware are deprived of a central target to attack in this fully secured and encrypted peer-to-peer or quasi-peer-to-peer (non-commutative peer-to-peer) network.

Asymmetric or non-commutative local rules-based sets of protocols may apply to provide enhanced privacy and security to enable a high level of personal trust, intimacy, and confidence or sentiment in the interactions of two or more individuals (edges of the graph) sharing postings, messaging and other activities on the Internet using its node-based communications. A non-commutative property of this network arises out of the fact that what may be a suitable and allowable message or signal from a first node (node A) to a second node (node B) may not be suitable or allowed in reverse, from node B to node A, wherein a different set or rules may apply. This is due to the asymmetry of its node-centric rules in both transmission and function.

In one instance, a node may send communications or data using trust parameters, intimacy parameters, and possibly interest parameters that may link nodes according to a star system model with node recall where:
Each node nₓ, of user x is to have a coded set of associated “friends, family and colleagues”, its group of nodes such as node n_{y} representing the trust and intimacy group, [Pₓ(y)], of its star shaped graph. Here [Pₓ(y)] may refer to a group P of contacts of user x (i.e. Pₓ) that include user or users y.
Each such node n_{y} connected in this way to node nₓ may be attributed with levels of trust T, as Tₓ(y), and intimacy I, as Iₓ(y), as well as A for Interest (golf, music, or other activities). Here the interests of any user y, like in (say) basketball, once coded in metadata or tags may influence what messaging user x may choose to send to user(s) y, from node nₓ to node n_{y}. Here Tₓ(y) may refer to levels of trust T that that user x (i.e. Tₓ) has associated with user or users y. Similarly, Iₓ(y) may refer to levels of intimacy I that user x (i.e. Iₓ) has associated with user or users y.

The respective notations Pₓ(y), Tₓ(y), and Iₓ(y) discussed above may alternatively be represented using notations P_{xy}, T_{xy}, and I_{xy}

A user may assign each of their contacts with a trust level and an intimacy level. Various representations may be used to identify trust levels and intimacy levels. In one instance, levels of trust and intimacy that may be assigned integers 1, 2, or 3 to identify respective levels of trust and intimacy. Here the number 1 could correspond to a lowest level, the number 2 could correspond to a medium level, and the number 3 could correspond to a high level. In other instances, levels of trust and intimacy may be represented using alphabetic characters (letters). Table 1 illustrates exemplary numbers and letters that could be used to identify respective levels of trust and intimacy, where the numbers could also be in a digital or continuous range (say) between zero and ten.

TABLE 1
Alphabetic and Numeric Level Representations
Alphabetic and Numeric Level Representations

| | | | |
|---|---|---|---|
| A | Trust High | 3 | Intimacy High |
| B | Trust Medium | 2 | Intimacy Medium |
| C | Trust Low | 1 | Intimacy Low |

Table 1 indicates an instance where a low trust level and a low intimacy level both correspond to the letter C or to the number 1, where a medium trust level and a medium intimacy level both correspond to the letter B and the number 2, and where a high trust level and a high intimacy level both correspond to the letter A and to the number 3.

These levels of trust and intimacy are personal to each ordered pair of users x and y and may be understood as the level of personal confidence/sentiment user x has in communicating with user y, represented as C_{xy} or Cₓ(y), and in reverse order in C_{yx} or C_{y}(x) where at times these two do not match. Herein, C_{xy}=C_{xy}(T_{xy}/I_{xy}), relates the level of confidence in terms of the trust of x in y as in T_{xy}=(low, medium or high) or any other set of such measures. Similarly, the same may apply to intimacy ratings for I_{xy}, the level of intimacy or closeness user x has with regard to user y. Here, the confidence that x has in communicating and participating in other activities with user y is represented by a pair, (T,I), of qualifiers or conditions that a sender user x holds regarding a user y; while signaling along the network edge from nₓ to n_{y}.

In an instance this may be represented in a table of pairs representing the sentiment or confidence/sentiment an initiator x has in dealing with a receiving party y in such a network, as shown in Table 2 or ordered pairs (T,I) where the numbers are indices representing levels such as low, medium and high or other kinds of ratings wherein a confidence/sentiment function C=C(T,I) yields human confidence/sentiment ratings or levels—its human master.

TABLE 2
Numeric Trust/Intimacy Ratings or Indices

| | Trust, | Trust, | Trust, |
|---|---|---|---|
| | Intimacy | Intimacy | Intimacy |
| Sets of | 3, 1 | 3, 2 | 3, 3 |
| Ordered Pairs | 2, 1 | 2, 2 | 2, 3 |
| | 1, 1 | 1, 2 | 1, 3 |

While tables 1 and 2 and related text discusses trust and intimacy levels (e.g. A, B, & C; and 3, 2, 1) that correspond to levels of confidence or sentiment, methods of the present disclosure may use any number of levels of trust and intimacy and these levels may instead be referred to as ratings or rankings of trust and intimacy where different combinations of trust ratings/rankings and intimacy ratings/rankings correspond to different ratings, rankings, or levels of confidence or sentiment. For example, ratings of trust may span a numerical range of 1 to 10 and ratings of intimacy may span numerical range of 1 to 5. For this reason, the terms level, rating, and ranking may be used interchangeably.

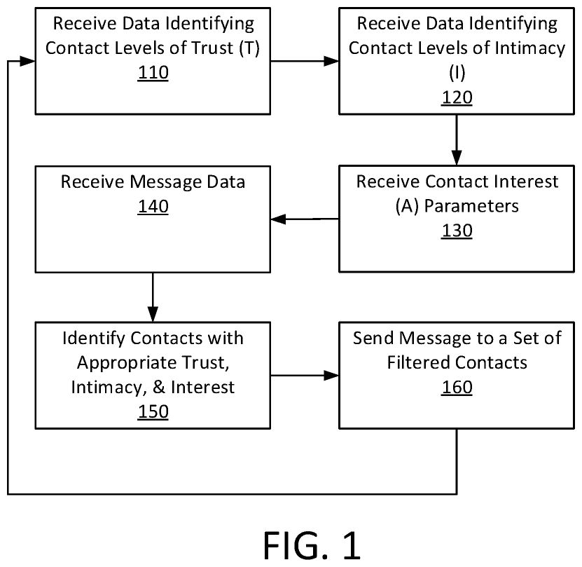

FIG. 1 illustrates a series of steps that may be performed at a user device when a user wishes to send messages to other user devices based on trust levels and intimacy levels. Here again, particular messages may only be sent to user devices of contacts that share a common interest with the user that drafted the message. FIG. 1 begins with step 110 where levels of trust are received. This may include a first user of a first device providing inputs to a user interface that associates their contacts (i.e. other users) with levels of trust. Each contact may be assigned a different trust level. Next in step 120, the first user may assign levels of intimacy to each of their contacts. Here again, each contact of the first user may be assigned a different level of intimacy. In certain instances, steps 110 and 120 may be performed for each respective user sequentially. This process may also include providing information that associates contact information with information that identifies user devices of each contact. Each of these contact user devices may have a respective unique identifier that allows messages to be sent directly to them. Exemplary unique device identifiers may include a phone number, a unique code, an avatar or other means that link a device such as a smartphone to a particular user. Such identifiers may be used to direct data sent from a computing device to one or more other computing devices. This may include sending data through a server configured to securely transfer message data.

Such methods may include sending the message or other data to one or more destinations using any identifier or identifiers (i.e. an email address, an identifier associated with a signal server, a universal resource locator (URL), a quick response (QR) code associated or a code stored at a near field communication—NFC—tag, another unique code, an avatar or other means) that link a device such as a smartphone to a particular user. By merely sending data to a computer that transfers received data, communications that include or are comprised of encrypted data may allow this transfer computer to distribute data to devices without the transfer computer being able to decrypt encrypted data in the sent data. Methods for transmitting data from a sending node to a recipient node may be performed using various different techniques and may use one or more different types of hardware apparatuses. Such techniques may include sending data using a signal server protocol, a transmission control protocol/Internet protocol (TCP/IP), a file transfer protocol (FTP), or a protocol consistent fiber to the premises (FTTP) configuration (e.g. point-to-point—PTP; or point-to-multipoint), or other protocol.

A transfer computer device to which messages or data are sent may be forwarded to other devices based on the identifier sent with the data. For example, when the identifier is a phone number, message data may be sent to a cell phone associated with the phone number. Encrypted data included in the message data may be decrypted by the cell phone based on that cell phone having shared encryption keys with the device that originally sent the message data. In an instance when identifier appears to be an email address or a URL to a person based on human readable text, that email address or URL may be may really be a pointer to that points to a recipient device or to a transfer computer. Data included in a message sent to the apparent “email address” or “URL” cold include information that appears to be clear text (unencrypted data) that is really information that includes identifiers to devices to which message data should be sent. This could include converting an email address, a URL, or the apparent clear text to identifies that identify one or more particular destination devices. Such methods may also be employed when QR codes or other codes are used. An initial set of information (e.g. email address, URL, clear text, QR code, or NFC code) may map to particular user devices. A transfer computer or a user device that receives such sets of information may be configured to convert that information to identifiers that identify particular user devices that have the capability of decoding encrypted data within a message. In this way even device identifiers may be obfuscated from a zone of the Internet.

For each pair of users, x and y, with x the initiator of an action on the network and y the receiving party, user x may elect to maintain a file or dossier Dₓ(y) on any of his or her contacts belonging to his or her personal group denoted by the group [Pₓ(y)] of his or her most personal contacts, or so called personal ‘peeps.’ This file may contain all forms of data representing user y as seen thru the eyes of user x, some of which may be numerical, others descriptive, and still others in the form of text remembrances, stories, impressions and the like as a form of instant recall or mental prosthesis. As these are but impressions of user x about user y, they may not even be accurate or factual, but merely what user x understands of user y.

The first user may enter information via a user interface that associates particular contacts with contact interest parameters in step 130 of FIG. 1. Contact data and contact interest parameters may be stored as sets of dossier data in a user's Dₓ(y) file of dossiers, including one's own dossier Dₛ(x). This may be performed by a user making selections from a set of interests or other information, may include the first user entering text that describes an interest, or both. For example, the first user may enter an interest of snow skiing. This may also include entering a skiing level for contacts that like to snow ski. A first user, Alex may identify that his contact Bob is an advanced skier, that his contact Joe is an intermediate skier, and that his contact Adam is a beginner skier. When Alex drafts a message regarding skiing, that message may be filtered based on trust levels, intimacy levels, interest types, and possibly interest levels. When Alex wishes to plan a helicopter skiing trip, he may draft a message in step 140 and he may then configure that message with levels of trust, intimacy, and possibly a type of interest. This may also include configuring the message to be sent only to contacts that have a minimum skiing level. For example, a message may be associated with contacts that have a skiing level of at least advanced (i.e. advanced or expert snow skiers). Step 150 may include receiving text typed into a user interface at the first user device. Message data may also be received by a user speaking into a microphone. Here text may be transcribed into a message using voice recognition.

In an instance when (say) Alex plans a fun ski trip where skiers of all skiing levels may be invited to, Alex may identify that a message he drafts may be sent to all contacts that like skiing. Of course, oftentimes Alex may also stipulate that only contacts that have at least (say) a medium trust levels and medium intimacy levels should be sent this message. The message may then be sent to user devices that belong to such a filtered set of contacts in step 160 of FIG. 1. This filtered set of contacts may be referred to as a group of contacts that “compatible” with parametric data, information, or ratings associated with the message. After step 160, program flow may move back to step 110 of FIG. 1.

Note that each of the user devices that a user x identifies as part of his or her group in his or her personal media network or star. Because of this and a multitude of additional features and capabilities disclosed herein, the present disclosure, involving personal ratings of others and their attached dossiers, along with ways and means of selecting as well as blocking communications therewith. Methods of the present disclosure may include ways of automating the selection of ad hoc groups to communicate based on trust, intimacy and other information. This may include the use of tagged parameters and ways of applying local protocols to individual links. This makes it clear that such personal media sites are far different from the popular but highly vulnerable and untrusted social media sites of today such as Facebook, Instagram and many others, where informed folks today avoid like the plague sharing their most private, secret, financial or sacred information in postings for fear of intrusions.

Instead, the present disclosure defines and enables a new form of Internet and its media architecture that deserves to be characterized as ‘personal media.’ This personal media is empowered by a distributed node topology network that functions via: 1) peer-to-peer encrypted communications architecture, 2) minimal server interactions, which are always out of reach of commercial networks and big data intrusions on privacy, 3) ways of communicating among users secured by the highest level of privacy and security, along with and further enabled by client ratings on trust and intimacy/closeness between individuals, 4) by matching messages to their audience via search, filtering and other capabilities using personal dossiers, only stored on users private devices, and thus out of the reach of public and commercial networks, 5) new convenient high speed ways of selecting just the right ad hoc audience for a message or posting, 6) an architecture that fosters and enables the evolution and use of smart contracts, and 7) communication rules and protocols defined on individual peer to peer links by the peers themselves that are non-commutative. Herein, locally stored private dossiers of personal contacts information act to empower and sustain the quality of the communications between parties that memory alone can seldom match. All of which will tend over time to raise trust and confidence and bring users and user groups ever closer together.

Rules set by a user on a node-by-node basis are not limited to specific levels of trust and intimacy, but may, for example, use rules that governs minimum levels of trust and intimacy and various other specifications. In such an instance a rule may identify that user devices of contacts that share the interest of baseball that have (say) a minimum trust level of medium and a minimum intimacy of medium should be sent a particular message. Here user devices of users that have a range of trust and intimacy levels and an interest in baseball will be sent the message according to a sharing rule. Given these and similar conditions, user devices belonging to contacts that have an interest in baseball that have trust/intimacy levels of (say) high-high, medium-high, high-medium, and medium-medium and no others will be sent this message according to such a sharing rule. These rules may be unique for any pair of users or user group, they provide a high degree of personalization and flexibility to users.

The combination of elements of trust (T), intimacy (I), and possibly interest (A) corresponds to a confidence or sentiment level C=Cₓ (y, Tₓ, Iₓ, A) for individual pairs x and y of users. This sentiment may also be used to control the nature, degree, and content that user x is willing to transmit to a computing device of user y in a message or signal Mₓ(y) that can only be sent to specific users. That given, the following are steps that may be followed for user x to send its message Mₓ(y) to user y. Once x has chosen the general nature of his or her message, that message be assigned a confidence rating C in terms of T, I, & A. By matching this, the confidence level required by user x for his message to go to a proposed recipients list, may be limited to those with an equal or greater confidence rating, or C levels.

With such message confidence ratings Cₓ, set by user x, a processor executing instructions out of a memory may identify which messages can be supplied to specific contacts of a user x to users y, zs that have a suitably high enough sentiment rating in terms of T, I, and A; and by such means and inventions, by a few quick strokes, enable and automate the selection of a small or large cohort suitable and qualified to receive a specific message or posting. Which means are employed for the convenience of user x and also so he or she may save a good deal of time and effort.

A processor of a computing device of user x may access structured data of user x stored alongside node nₓ in the network to provide information that allows user x to contextualize and enrich a message user he or she is drafting. This allows user x to draft messages that are suitable, sensitive, precise, appropriate, and useful.

The personal dossiers mentioned above may include information (i.e. parameters) that identifies levels of trust and intimacy that a particular user has associated with their contacts. These dossiers may also induct information that identifies interests of their contacts. Once an individual has associated a set of parameters with a particular set of data, contacts that have a matching set of parameters may be identified and each of these contacts may be sent that particular data set. Because of this, dossier data of a large number of contacts may be filtered through to identify only those contacts that are “compatible” with rating parameters associated with a particular message or data set. For example, in an instance when a user has 100 contacts and has assigned a level of trust of 3, an intimacy of 2, and an interest of travel to a message, only contacts that have a compatible level of trust, level of intimacy, and interest in travel will be sent the message. This may result in only 10 of the user's 100 contacts being sent the message. The present process allows for data to be shared with compatible contacts virtually using a single stroke according to a set of rules based on previously entered dossier data and based on a set of parametric information assigned to the message or data set.

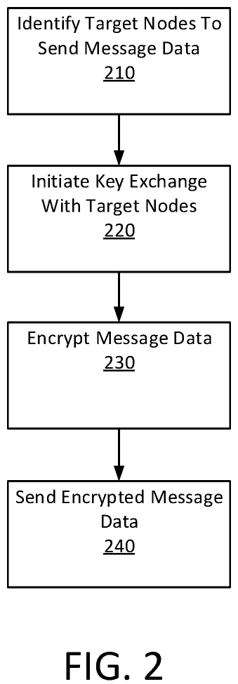

FIG. 2 includes a series of steps that may belong to step 160 of FIG. 1. FIG. 2 begins with step 210 where target nodes (specific contact user devise) are identified to send message data to. This process may include initiating a key exchange with target nodes in step 220 of FIG. 2, encrypting that message data in step 230, and sending that encrypted message data to the nodes identified in step 210. This means that no intermediate devices will be able to decrypt the message data. In fact, no intermediate device may be allowed to store this encrypted data and even if they did so, forms of encryption, such as RSA encryption may make this message data secure from third parties. Here, only the compute nodes identified in step 210 that have encryption keys shared in step 220 will be able to decrypt the message data and provide a message to a user of those identified compute nodes. This message data may be provided in the form of text or may be provided via an audio message. An audio message may be proved based on converting text to audio.

Security and privacy of message data may be maintained by using a combination of techniques associated with the National Institute of Standards and Technology (NIST) standards and a secure hash algorithm of various sorts. For example, the 256-b secure hash algorithm (commonly referred to as the SHA-2 hash algorithm) developed by Massachusetts Institute of Technology (MIT) may be used as part of a security protocol. Other examples of hash algorithms that may be used include yet are not limited to the MD5 and Script algorithms. Security may also be enhanced by using an extended triple Diffie-Hellman secure key exchange that is sometimes referred to as X3DH that establishes a shared secret key between two parties (i.e. computing devices or compute nodes) that mutually authenticate each other using public keys. Using a technique such as X3DH provides the benefits of forward secrecy and cryptographic deniability. This X3DH technique may be used for asynchronous settings where one user, “Bob,” is offline yet has published some information to a server. This may allow device nodes to leverage extended triple Diffie-Hellman security in a node centric system where some communications may be made to a private server. Such a private server may be a private signal server that executes instructions associated with a forked or derivative version of open source “signal” code. This may allow for a node centric system that is not completely and totally decentralized disintermediate WEB 3.0 This may also provide users with increases in privacy security and may help leverage processing power based on the client being a node by which communications are conducted. These methods may also use end to end encryption through devices implementing a form of open source signal code server, for example. Despite having minimal server calls to support communications, private computers or computer networks may have no access to information stored on a computing device (e.g. a computer or phone) of a user. Such a design allows for data sent between nodes to be secured at and only accessible by specific nodes that receive data sent from another node in a private media network.

In certain instances, levels of trust and intimacy may be assigned using color codes. Trust and intimacy levels may be assigned, to discrete content included in messages or to an entire message. Once a message is composed, a user may add text using color highlights or colored text. These colors may be combined with a bias that may adjust filtering of specific portions of text. The data of table 3 identifies how colors may be interpreted. The colors identified in table 3 are red, pink, orange, yellow, and none.

TABLE 3
Trust/Intimacy Combined Color Codes

| | Trust, | Trust, | Trust, |
|---|---|---|---|
| | Intimacy | Intimacy | Intimacy |
| Numeric & | 3, 1: Orange | 3, 2: Pink | 3, 3: Red |
| Color | 2, 1: Yellow | 2, 2: Blue | 2, 3: Pink |
| Trust/Intimacy | 1, 1: None or | 1, 2: Yellow | 1, 3: Orange |
| Representation | Green | | |

In table 3, the color red may correspond to a highest level of sentient, where trust and intimacy (3, 3) are both high. The color blue may correspond to a medium level of both trust and intimacy (2, 2). No color or a green color may correspond to a lowest sentiment/confidence level both trust and intimacy (1, 1). The colors pink (T/I of 3, 2 or 2, 3), orange (T/I of 3, 1 or 1, 3), and yellow (T/I of 2, 1 or 1, 2) may be used to identify text of some intermediate level that may be raised or lowered to a high, medium, or low sentiment/confidence level based on another set of settings. These other settings may identify that text of a particular intermediate level should be raised to a next higher level or lowered to lower level. Pink combined with a raise may result in a high sentiment level (e.g. 3, 3 red), pink combined with lower may result in a medium sentiment level (2, 2 blue), orange combined with a raise setting may result in a medium sentiment level (2, 2 blue), orange combined with a lower setting may result in a low sentiment level, yellow combined with a raise sentiment level may result in a medium sentiment level, and yellow combined with a lower sentiment level may result in a low sentiment level.

The use of color highlighting or text (e.g. green) may be used to identify text that may be broadcast to any contact from a primary device and that may possibly forwarded to secondary contacts. Other text in that message may be transmitted to primary contacts or secondary contacts based on other settings (e.g. an overall sentiment—trust/intimacy—level).

Methods of the present disclosure may allow user Sam D. to assign specific contacts with discrete levels of trust and intimacy. This may be accomplished by making entries in a user interface. This process may include identifying specific devices that belong to their respective contacts. For example, a user may assign their friend Nancy A. with a medium level of trust (e.g. the letter B) and a high level of intimacy (e.g. the letter A) and may identify a user device that belongs to Nancy A. with a phone number of (510) 555-0101. This method may also include associating specific messages with levels of trust and intimacy.

In certain instances, phone numbers or other identifiers may be hashed and/or salted to ensure a standard long form key output. Such techniques may prevent nefarious actors from colluding in attempts to interfere with or inappropriately access data associated with (i.e. hack) the system. This may include a cryptographic hash of an identifier (and/or other information) or adding random bits to the identifier (and/or other information) and performing a cryptographic hash of the random bits and the identifier (and/or other information).

Rules could be used to allow a processor of Sam's user device to identify which messages that Sam drafts that will be sent to other user devices. Any messages sent from Sam's user device to Nancy's user device must conform to the rules set by Sam. Such a rule could identify that message A can only be sent to devices of users that have been assigned a trust/intimacy rating of B, A (medium trust, high intimacy).

A processor executing instructions out of a memory may also make other evaluations when identifying which message should be sent to which specific user devices. These other evaluations could identify users that share a common interest, for example skiing. In such an instance, messages that relate to skiing could be sent to user devices according to a message rule that associates the interest of skiing with specific trust and intimacy levels. This rule may specify that a message associated with the interest of skiing can only be sent to user devices that are assigned a medium trust level and a high intimacy level. In an instance when a user device owned by Sam D. sends messages to user devices of Sam's contacts, that the user device of Nancy A. will be sent that message.

User x may add various rules on how the message can be transmitted to users y, including controls over the content of messages passed on, or portions of data therein, that may be forwarded by users y to those in its star system. The nature of the message may necessitate other rules to guide the level of security and privacy that is required prior to such transmission. Plus, perhaps, feedback to the originating user x on how its signal was received and perhaps further transmitted.

When user y attempts to reply to this message, it may be based on his or her (possibly different) level of confidence in user x, C_{y}(x) based on different T, I, and A levels than user x used in his message to user y, i.e., non-commutativity. Further, on the basis of C_{y}, y may not even be willing or able to reply at all. Herein we have the benefit of non-commutativity commonly present in face to face human communications, where how a party A feels about a contact B can differ greatly in how party B in return feels about and acts toward party A.

Whenever a user x wishes to cast his or her message or posting beyond their own personal star of contacts Pₓ(y), they can only do so with the concurrence and assistance of one or more of their users y. Meaning y agreeing to pass the posting on to his or her group of members P_{y}(Z) within their own star of personal contacts. This may be enabled, layer by layer, with consent, over a selection of surrounding users of user y from his or her circle P_{y}(Z). Herein its members z would receive the message (or portions of that message) and possibly have it go on and on with their consent to other nodes in a similar fashion. This is messaging via multiple personal stars, or star clusters, to communicate in an outbound fashion broadly, where at each node any further forwarding is based on permission as well as a variety of trust T and intimacy I filters along the network.

The method by which this can be established, may control and monitor the transfer of messages by applying a set of to be node-centric based rules that ensure that the sensitive nature of the original message is fully preserved across a span of the message's reach. In order to accomplish this objective, the original message may be provided with message redacting rules as it is propagated across many user devices of users in the [Pₓ(y)], [P_{y}(z)], [P_{z}(u)] stars of contacts of an x, or y, or z . . . associated with their star configurations. Such redacting rules may provide indicators to recipients reminding them to limit their forwarding of the message to parties that meet a specific indicated level of trust, intimacy, and possibly known interest. Alternatively, or additionally redacting rules may be automatically enforced based on a set of rules that may have been shared between devices.

Such resending of an original message may depend on the confidence or sentiment levels Cₓ, C_{y}, C_{z} . . . of the star systems surrounding users x, y, and z, namely the sets [Pₓ(y)], [P_{y}(z)], [P_{z}(u)] . . . . This ensures localized rules based on trust and intimacy continue to be honored across the greater network of linked nodes. As a result, various complex architectures can be put in place that meet the local node-centric non-commutative nature of the network while preserving the integrity of the messages that are propagated broadly across such star clusters within the network.

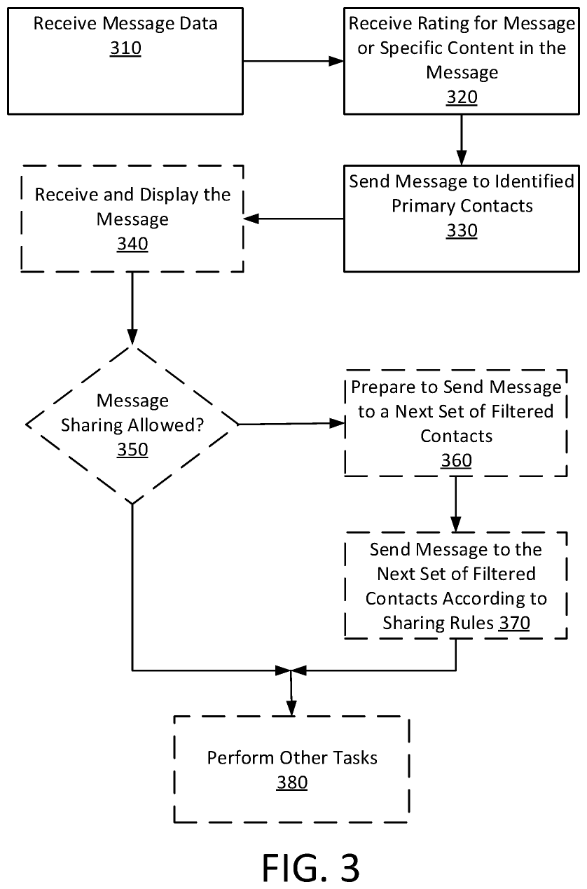

FIG. 3 illustrates actions that may be performed at two different computing devices that part of a node-centric non-commutative communication network. FIG. 3 begins with step 310, where message data is received at a first computing device (i.e. node) as discussed in respect to step 140 of FIG. 1. Next, in step 320 a rating for the message may be established. This rating may include assigning levels of trust and intimacy to a message or specific text in a message and may also include identifying a topic of interest. The message may then be sent to other user devices (i.e. nodes) who's users have been assigned an appropriate level of trust and intimacy. The sending of this message may also only be sent to user devices of users that share the topic of interest.

Steps 340 through 380 of FIG. 3 may be performed a second user device that receives the message from a first user device. In step 340, the second user device may receive and display the message after which program flow may move to determination step 350 that identifies if the message is allowed to be shared with contacts of the second user device, when no program flow may move to step 380 where other tasks are performed. When the message can be shared to contacts of the second user, program flow may move to step 360 where the message or portions of that message may be shared with a set of user devices that belong to contacts of the second user. This may be performed based on settings set at the second user device or may be shared based on settings set at the first user device and possibly at the second user device. Next in step 370, the message or portion of that message may be shared with user devices of the identified contacts of the second user. After step 370, program flow may move to step 380 where other tasks are performed.

While FIG. 3 does not show the second user device sending a response to the first user device, this may occur based on levels of trust and intimacy set at the second user device. In an instance when the first user has assigned a high level of intimacy to the second user and where the second user has assigned a medium level of intimacy to the first user and when the message sent from the first user device to the second user device has been assigned a high level of intimacy, a set of sharing rules (i.e. sharing-criteria) may enforced by the second user device may not allow a response message to be sent to the first user device. These sharing rules or criteria may also identify interests, preferences, or bias of particular users that may also be used to filter which messages or portions of messages (e.g. text data) that can be sent to other user devices.

A set of user devices may be included in a system of devices where each device in this system may related to other devices in this system based on sets of contact information. In an instance when a first user has 10 contacts, each of those 10 contacts may be assigned a level of trust and a level of intimacy by the first user. Data stored persistently at a user device of this first user may identify user devices of each of their respective contacts and this persistent data may identify other information about each respective contact. This contact information may be protected based on that data being stored in an encrypted format and this contact information may be protected via passwords or other means. This contact information could identify specific user devices that belong to particular users and could stored as one or more sets of dossier information discussed above. This contact information may store information about contacts of a user that help the user remember personal details about their contacts. For example, this contact information may identify a birthdate, an address, a number of children, or other details about a person. Before sending a message to a contact, a user may review information relating to that person. Because of this, stored personal information may act as a sort of mental prosthesis that allows users to make postings or write messages are more accurate, trustworthy, or intimate.

Methods consistent with the present disclosure may rely on fully encrypted communications that may be implemented using a distributed ledger technology that allows use of new WEB 3.0 semantic WEB and Blockchain technologies. Functions of the present disclosure may allow users to automatically share data based on interests, preferences, biases within the framework of levels of trust and levels of intimacy.

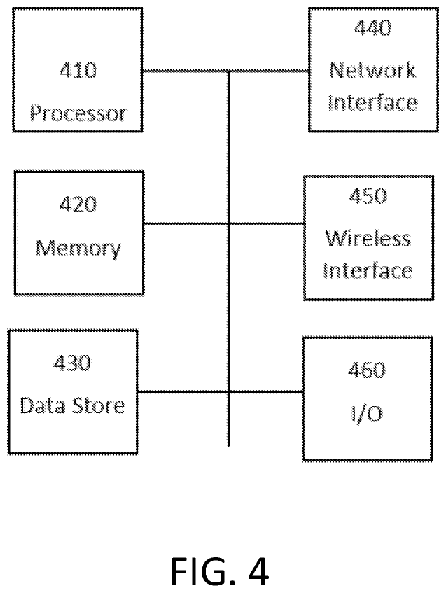

FIG. 4 illustrates a computing system that may be used to implement an embodiment of the present invention. FIG. 4 includes processor 410 that may execute instructions out of memory 420. FIG. 4 also include mass data store 430, network interface 440, wireless communication interface 450, and input/outputs (I/O) 460. Processor 410 may execute instructions out of memory 420. Communications may be sent via communication interface 440 or via I/O 460 to other computing devices.

The computing device of FIG. 4 may be a device such as a desktop computer, notebook computer, tablet, or cell phone computing device A network interface or wireless communication interface may communicate with a remote computing device. Computing devices consistent with the present disclosure may also include a display that displays a user interface that allows users to set levels of trust and intimacy. This display may also be used to prepare messages to send or to display received messages. Wired network connections may include any standard wired network known in the art (Ethernet for example). Wireless communications may include communication signals consistent with cell phones, with 802.11 Wi-Fi, Bluetooth, radio, cellular, or other wireless communication mediums.

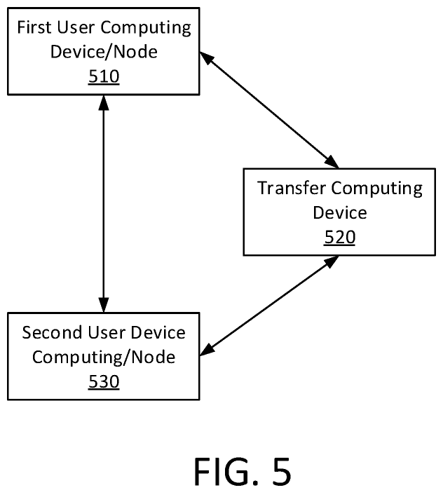

FIG. 5 illustrates a first and a second computing device as well as a transfer computing device that may be used to share data in a secure way according to rules and keys discussed in respect to FIGS. 1-3. FIG. 5 includes a first user computing device (or node) 510, a transfer computing device 520, and a second user computing device (or node) 530. As discussed above, transfer computing device 520 may be used to transfer data based on identifiers that are associated with transferred data. Transfer computing device 520 may be a computer accessible by the Internet or other computer network (e.g. cellular network) or combination thereof. The various computing devices of FIG. 5 may include the components discussed in respect to FIG. 4. FIG. 5 also illustrates that the first computing device 510 may communicate with the second computing device 530 directly or via transfer computing device 520. In certain instances, transfer computing device 520 may be implemented as or in a manner consistent with operations of a signal server.

While various flow diagrams provided and described above may show a particular order of operations performed by certain embodiments of the invention, it should be understood that such order is exemplary (e.g., alternative embodiments can perform the operations in a different order, combine certain operations, overlap certain operations, etc.).

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claim.

What is claimed is:

1. A method for selectively sending messages, the method comprising:
receiving at a first user device input that identifies a trust level and an intimacy level to associate with a second user, wherein the trust level and the intimacy level corresponds to a sentiment rating of the second user;
accessing contact information that identifies that the second user operates a second user device;
receiving message data at the first user device;
identifying that the message data corresponds to the sentiment rating of the second user; and
sending the message data to the second user device based on the identification that the message data corresponds to the sentiment rating of the second user and based on the contact information identifying that the second user operates the second user device.

2. The method of claim 1, further comprising:
receiving information that identifies an interest of the second user; and
identifying that a sharing-criteria associated with the message data identifies the interest, wherein the sending of the message to the second user device is also based on the interest of the second user being included in the sharing-criteria.

3. The method of claim 1, further comprising:
accessing dossier data of the second user that includes personal information of the second user; and
providing the dossier data of the second user to a first user such that the first user can be reminded of the personal information of the second user, wherein the dossier data of the second user provided to the first user via a user interface at the first user device.

4. The method of claim 1, further comprising receiving a message from the second user device.

5. The method of claim 4, further comprising:
identifying that the information included in the received message includes a sharing-criteria associated with a second sentiment rating that corresponds to a second trust level and a second intimacy level set by the second user;
identifying one or more other users that correspond to the second-sharing criteria; and
sending the received message to user devices of the one or more other users based on the identification that the one or more other users correspond to the second-sharing criteria.

6. The method of claim 1, wherein the first processor of the first user device executes additional instructions to:
exchange keys with the second user device; and
encrypt the message data before sending the message data to the second user device after the exchanging of the keys with the second user device.

7. The method of claim 1, further comprising:
receiving data that identifies a trust level and an intimacy level to associate with the message data;
filtering through sets of user dossier data to identify a plurality of users with a sentiment rating that corresponds to the trust level and the intimacy level associated with the message data; and
sending the message to user devices of the identified plurality of users based on the filtering of the sets of user dossier data.

8. The method of claim 1, further comprising identifying a sharing factor to associate with the message data, wherein the sending of the message to the second user device is also based on the sharing-criterial including the sharing factor and on the second user being associated with the sharing factor.

9. The method of claim 8, wherein the sharing factor includes at least one of an interest, a preference, or a bias.

10. The method of claim 8, further comprising identifying that the second user device can be automatically sent the message data based on the sentiment rating of the second user corresponding to the sharing criteria.

11. A system for selectively sending messages, the system comprising:
a first user device that includes a first processor and a first memory that stores instructions of a set of program code, wherein the first processor executes the instructions of the set of program code out of the first memory to:
evaluate input that identifies a trust level and an intimacy level to associate with a second user, wherein the trust level and the intimacy level corresponds to a sentiment rating of the second user,
receive message data,
identify that the message data corresponds to the sentiment rating of the second user, and
prepare to send the message data to the second user based on the identification that the message data corresponds to the sentiment rating of the second user, wherein the message data is sent to the second user device based on the contact information identifying that the second user operates the second user device.

12. The system of claim 11, further comprising the second user device that includes a second memory that stores the instructions of the set of program code and a second processor that executes the instructions of the set of program code, wherein the first processor executes instructions to:
receive information that identifies an interest of the second user, and
identify that a sharing-criteria associated with the message data identifies the interest, wherein the sending of the message to the second user device is also based on the interest of the second user being included in the sharing-criteria.

13. The system of claim 11, further comprising:
a persistent data store accessible by the first user device that stores dossier data of the second user that includes personal information of the second user; and
a user interface that provides the dossier data of the second user to the first user such that the first user can be reminded of the personal information of the second user.

14. The system of claim 11, wherein a message from the second user device is received.

15. The system of claim 14, wherein the processor of the first user device executes instructions to:
identify that the information included in the received message includes a sharing-criteria associated with a second sentiment rating that corresponds to a second trust level and a second intimacy level,
identify one or more other users that correspond to the sharing-criteria, and
send the received message to user devices of the one or more other users based on the one or more other users corresponding to the sharing-criteria.

16. The system of claim 11, further comprising a persistent data store accessible by the first user device that stores an encryption key for securely exchanging data with the second user device, wherein the message data is encrypted using the encryption key before sending the message data to the second user device.

17. The system of claim 11, further comprising a third user device that includes a third memory and a third processor that executes instructions of the set of program code out of the third memory, wherein:
the first user device receives a message from the second user device that includes a sharing-criteria and the message is sent to the third user device based on the sharing-criteria included in the message corresponding to a second sentiment rating associated with a user of the third user device.

18. The system of claim 17, wherein the sharing-criteria factor identifies at least one of an interest, a preference, or a bias associated with the third user.

19. A non-transitory computer-readable storage medium having embodied thereon a program executable by a processor to implement a method for selectively sending messages, the method comprising:
receiving input that identifies a trust level and an intimacy level to associate with a second user, wherein the trust level and the intimacy level corresponds to a sentiment rating of the second user;
accessing contact information that identifies that the second user operates a second user device;
receiving message data;
identifying that the message data corresponds to the sentiment rating of the second user; and
sending the message data to the second user device based on the identification that the message data corresponds to the sentiment rating of the second user and based on the contact information identifying that the second user operates the second user device.

20. The non-transitory computer-readable storage medium of claim 1, the program further executable to:
receive data that identifies a trust level and an intimacy level to associate with the message data;
filter through sets of user dossier data to identify a plurality of users with a sentiment rating that corresponds to the trust level and the intimacy level associated with the message data; and
send the message to user devices of the identified plurality of users based on the filtering of the sets of user dossier data.
